(19) United States
(12) Patent Application Publication
(10) Pub. No.: US 2025/0102641 A1
(43) Pub. Date: Mar. 27, 2025

(54) UNSHIELDED TWISTED PAIR-TO-COAXIAL CONVERTER

(71) Applicant: Apple Inc., Cupertino, CA (US)

(72) Inventors: Abhilash Rajagopal, San Jose, CA (US); Chentian Zhu, San Jose, CA (US); Heegon Kim, Santa Clara, CA (US); James C. Chiappe, Walnut Creek, CA (US)

(21) Appl. No.: 18/811,191

(22) Filed: Aug. 21, 2024

Related U.S. Application Data
(60) Provisional application No. 63/584,800, filed on Sep. 22, 2023.

(51) Int. Cl. G01S 7/4861; H01B 11/12

(52) U.S. Cl. CPC G01S 7/4861; H01B 11/125

(57) ABSTRACT

A system includes processing circuitry communicatively coupled to a coaxial cable as well as a sensor, such as a light detection and ranging (LIDAR) sensor communicatively coupled to an unshielded twisted pair (UTP) cable. The processing circuitry and LIDAR sensor may be communicatively coupled to one another via a UTP-to-coaxial converter that is communicatively coupled to both the coaxial cable and the UTP cable. The UTP-to-coaxial converter includes filter circuitry configured to receive one or more signals generated by the LIDAR sensor and generate one or more filtered signals by blocking a portion of the one or more signals having a frequency in a first frequency range. The UTP-to-coaxial converter is configured to send the one or more filtered signals to the processing circuitry via the coaxial cable.

### CROSS-REFERENCE TO RELATED APPLICATION

This application claims the benefit of U.S. Provisional Application No. 63/584,800, filed Sep. 22, 2023, entitled “UNSHIELDED TWISTED PAIR-TO-COAXIAL CONVERTER,” which is incorporated by reference in its entirety for all purposes.

### BACKGROUND

The present disclosure relates generally to wired communications, and more specifically to transmitting signals between different types of communication cables.

In electronics and communications, various types of cables may be used to send signals (e.g., electrical signals) between two devices. Examples of types of cables include twisted pair cables and coaxial cables. Twisted pair cables typically include two conductors that are twisted together, and twisted pair cables may be shielded (e.g., with twisted pairs inside a cable being shielded) or unshielded. In electrical systems, some devices may have connections for a particular type of cable. For example, one particular component may be connectable to a twisted pair cable, while another device may be connectable to a coaxial cable. In such a scenario, for the devices to be able to communicate with one another and for such communications between the device to have desired characteristics, it may be desirable to enable communication between the two different types of cables.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a system includes a light detection and ranging (LIDAR) sensor configured to generate one or more signals indicative of sensor data. The LIDAR sensor includes a first unshielded twisted pair (UTP) connector. The system also includes processing circuitry communicatively coupled to a first coaxial connector. Additionally, the system includes a UTP-to-coaxial converter that includes a second UTP connector communicatively coupled to the first UTP connector of the LIDAR sensor via a UTP cable. The second UTP connector is configured to receive the one or more signals via the UTP cable. The UTP-to-coaxial converter also includes filter circuitry configured to receive the one or more signals from the second UTP connector and generate one or more filtered signals by blocking a portion of the one or more signals having a frequency in a first frequency range. Moreover, the UTP-to-coaxial converter includes a second coaxial connector coupled to the filter circuitry. The second coaxial connector is configured to receive the one or more filtered signals from the filter circuitry and to send the one or more filtered signals to the processing circuitry via a coaxial cable that communicatively couples the first coaxial connector and the second coaxial connector.

In another embodiment, an untwisted pair (UTP)-to-coaxial converter including a housing and a first UTP connector at least partially within the housing. The first UTP connector is configured to be communicatively coupled to a second UTP connector of a light detection and ranging (LIDAR) sensor via a UTP cable. The first UTP connector is also configured to receive one or more signals indicative of sensor data from the LIDAR sensor via the UTP cable. The UTP-coaxial converter also includes filter circuitry within the housing. The filter circuitry is configured to receive the one or more signals and generate one or more filtered signals by blocking a portion of the one or more signals having a frequency in a first frequency range. Additionally, the UTP-to-coaxial converter includes a first coaxial connector at least partially in the housing. The first coaxial connector is configured to receive the one or more filtered signals from the filter circuitry and to send the one or more filtered signals to processing circuitry via a coaxial cable that communicatively couples the first coaxial connector and a second coaxial connector that is communicatively coupled to the processing circuitry.

In yet another embodiment, a system includes a light detection and ranging (LIDAR) sensor configured to generate one or more signals indicative of sensor data. The LIDAR sensor includes a first unshielded twisted pair (UTP) connector. The system also includes processing circuitry communicatively coupled to a first coaxial connector. Additionally, the system includes a UTP-to-coaxial converter that includes a housing. The housing has an upper portion and a base portion that are configured to interface with one another. The UTP-to-coaxial converter also includes a second UTP connector at least partially within the housing. The second UTP connector is communicatively coupled to the first UTP connector of the LIDAR sensor via a UTP cable. Also, the second UTP connector is configured to receive the one or more signals via the UTP cable. Moreover, the UTP-to-coaxial converter includes filter circuitry within the housing. The filter circuitry is configured to receive the one or more signals from the second UTP connector and to generate one or more filtered signals by blocking a portion of the one or more signals having a frequency in a first frequency range. Furthermore, the UTP-to-coaxial converter includes a balun within the housing that is configured to receive the one or more filtered signals from the filter circuitry. The UTP-to-coaxial converter also includes a second coaxial connector that is at least partially in the housing and communicatively coupled to the balun. The second coaxial connector is configured to receive the one or more filtered signals from the balun as well as to send the one or more filtered signals to the processing circuitry via a coaxial cable that communicatively couples the first coaxial connector and the second coaxial connector. Additionally, the UTP-to-coaxial converter includes a plurality of gaskets within the housing. The plurality of gaskets is configured to seal an interior of the housing from an exterior environment outside of the housing. The plurality of gaskets includes a first gasket configured to interface with the second UTP connector and the housing, a second gasket configured to interface with the second coaxial connector and the housing, and a third gasket configured to interface with the upper portion and the base portion of the housing to seal a base section of the interior of the housing.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of a sensor system, according to embodiments of the present disclosure;

FIG. 2 is a block diagram of the sensor system of FIG. 1 in which components of the untwisted pair (UTP)-to-coaxial converter are illustrated, according to embodiments of the present disclosure; and

FIG. 3 is a perspective view of the UTP-to-coaxial converter of FIG. 1 and FIG. 2, according to embodiments of the present disclosure.

### DETAILED DESCRIPTION OF SPECIFIC EMBODIMENTS

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately.” “near.” “about.” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on. Additionally, the term “set” may include one or more. That is, a set may include a unitary set of one member, but the set may also include a set of multiple members.

This disclosure is generally directed to enabling the transmission of signals between different types of communication cables. As noted above, various types of cables may be used to send signals (e.g., electrical signals) between two devices. For instance, types of cables include, but are not limited to, twisted pair cables and coaxial cables. Twisted pair cables typically include two conductors that are twisted together, and twisted pair cables may be shielded (e.g., with twisted pairs inside a cable having shielding) or unshielded. In electrical systems, some devices may have connections for a particular type of cable. For example, one particular component may be connectable to a twisted pair cable, while another device may be connectable to a coaxial cable. In such a scenario, for the devices to be able to communicate with one another and for such communications between the device to have desired characteristics, it may be desirable to enable communication between the two different types of cables.

Embodiments herein provide various apparatuses and techniques to enable unshielded twisted pair (UTP)-to-coaxial communication. In particular, the embodiments described herein relate to a UTP-to-coaxial converter as well as systems that may include the UTP-to-coaxial converter. As also discussed below, the UTP-to-coaxial converter may include various components that enhance performance and enable the UTP-to-coaxial converter to be used in particular environments, such as in a vehicle. For example, the UTP-to-coaxial converter may include filtering circuitry to filter out signals having particular frequencies and gaskets to seal a housing of the UTP-to-coaxial converter (and components within the housing) from an exterior environment outside the housing of the UTP-to-coaxial converter. While techniques herein are described below with respect UTP cables and a UTP-to-coaxial converter, it should be noted that the presently disclosed techniques may be utilized for any untwisted pair cable, including, but not limited to, shielded twisted pair cables.

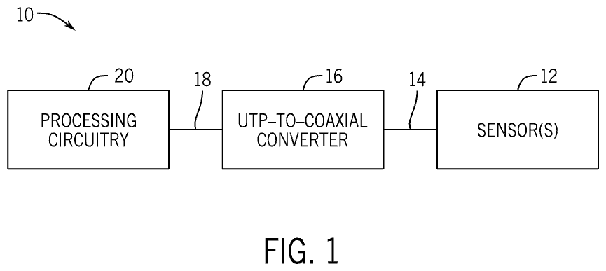

FIG. 1 is a block diagram of a sensor system 10, according to embodiments of the present disclosure. The sensor system 10, as illustrated, includes one or more sensors 12, a UTP cable 14 coupled to the one or more sensors 12, a UTP-to-coaxial converter 16 communicatively coupled to the one or more sensors 12 via the UTP cable 14, a coaxial cable 18 coupled to the UTP-to-coaxial converter 16, and processing circuitry 20 communicatively coupled to the UTP-to-coaxial converter 16 via the coaxial cable 18. The sensor system 10 may collect sensor data via the one or more sensors 12, which may transmit signals via the UTP cable 14 to the UTP-to-coaxial converter 16. As described in more detail below, the UTP-to-coaxial converter 16 may perform operations on the signals (e.g., filter the signals) and send the resulting signals to the processing circuitry 20 via the coaxial cable 18. Before describing the components of the sensor system 10 individually, it should be noted that the sensor system 10 may be included in several different environments and/or configured for each particular environment. As a non-limiting example, the sensor system 10 may be included in an automotive vehicle (e.g., a motor vehicle), which may include cars, buses, motorcycles, off-road vehicles, light trucks, trucks, and other vehicles that may be propelled by an engine or a motor (e.g., an electric motor powered by a battery or battery system). Accordingly, the automotive vehicle may have an internal combustion engine (ICE), and the automotive vehicle may include a hybrid vehicle (e.g., a vehicle with an engine (e.g., an ICE) and one or more electric motors), an electric vehicle (EV) that has one or more electric motors, or any suitable vehicle.

The one or more sensors 12 may include any suitable form of sensor capable of detecting an event or change, including analog and digital sensors. For example, the one or more sensors 12 may include image sensors (e.g., cameras or other devices capable of capturing images, thermal imaging sensors (e.g., infrared or ultraviolet sensors), radar sensors, sonar sensors, light detection and ranging (LIDAR) sensors), monitoring sensors (e.g., traffic monitoring sensors or other sensors capable of monitoring a status of one or more vehicles, weather monitoring sensors, environmental sensors, gas-detecting sensors, and more), or both image and monitoring sensors. For instance, in embodiments of the sensor system 10 that are included in a vehicle, the one or more sensors 12 may include LIDAR sensors or other ranging sensors that may collect data regarding an area around or near the vehicle (e.g., to build three-dimensional maps or images of such an area). Thus, the one or more sensors 12 may be included in a LIDAR system.

The UTP cable 14 may include any suitable unshielded twisted pair cable. In one embodiment, the UTP cable 14 may include a twisted pair cable that does not have pair shielding. In other words, twisted pairs within such a cabls are not shielded from other twisted pairs within the cable. Thus, such twisted pair cables may include twisted pair cables that have cable shielding. Accordingly, the UTP cable 14 may include a U/UTP (no cable shielding and no twisted pair shielding), an F/UTP (foil cable shielding and no twist pair shielding), an S/UTP (braiding cable shielding and no twisted pair shielding), or an SF/UTP (braiding and foil cable shielding with no twisted pair shielding) cable as defined by International Organization for Standardization (ISO)/International Electrotechnical Commission (IEC) standard 11801, entitled “Information technology-Generic cabling for customer premises” or ISO/IEC standard 11801-1 (entitled “Information technology-Generic cabling for customer premises-Part 1: General requirements. Examples of cables that may be UTP cables (including the UTP cable 14) include, but are not limited to Category 3 (Cat 3) cables, Category 4 (Cat 4) cables, Category 5 (Cat 5) cables, Category 5e (Cat 5e) cables, some Category 6 cables (Cat 6) cables (e.g., unshielded Cat 6 cables), some Category 6A (Cat 6A) cables (e.g., unshielded Cat 6A cables), some Category 8.1 (Cat 8.1) cables (e.g., unshielded Cat 8.1 cables), and some Category 8.2 (Cat 8.2) cables (e.g., unshielded Cat 8.2 cables) as defined by various standards such as American National Standards Institute (ANSI)/Telecommunications Industry Association (TIA) standard ANSI/TIA-568 (including any revision of ANSI/TIA-568 such as ANSI/TIA-568-A, ANSI/TIA-568-B. ANSI/TIA-568-C, and ANSI/TIA-568-D), ISO/IEC 11801, IEC standard 61156 (“Multicore and symmetrical pair/quad cables for digital communications”). In some embodiments, the UTP cable 14 may be any suitable twisted pair cable in accordance with (or that complies with) the 100BASE-T1 (e.g., as defined by Institute of Electrical and Electronics Engineers (IEEE) Standard 802.3bw-2015). and/or 1000BASE-T1 (e.g., as defined by IEEE Standard 802.3 bp-2016) standards. Thus, the UTP cable 14 may be a 100 megabit cable (e.g., capable of transferring 100 megabits of data per second) or a gigabit Ethernet cable (e.g., capable of transferring one gigabit of data per second).

As mentioned above, it should be noted that other types of twisted pair cables may be utilized in other embodiments. For example, in other embodiments, the UTP cable 14 may include a shielded twisted pair cable in which twisted pairs with the cable are shielded from one another, for instance, by foil. Examples of types of twisted pair cables with foil shielding include U/FTP (no cable shielding with foil twisted pair shielding) cables, F/FTP (foil cable shielding and foil twisted pair shielding) cables, S/FTP (braiding cable shielding and foil twisted pair shielding) cables, and SF/FTP (braiding and foil cable shielding with foil twisted pair shielding) cables as defined by ISO/IEC 11801 (or any version of ISO/IEC 11801). Examples of shielded twisted pair cables that may be utilized include, but are not limited to, some Cat 6 cables (e.g., shielded Cat 6 cables), some Cat 6A cables (e.g., shielded Cat 6A cables), Category 7 (Cat 7) cables, Category 7A (Cat 7A cables), some Cat 8.1 cables (e.g., shielded Cat 8.1 cables), and some Cat 8.2 cables (e.g., shielded Cat 8.2 cables).

The UTP-to-coaxial converter 16 may include an electronic device that may be connected to both the UTP cable 14 and the coaxial cable 18. Accordingly, the UTP-to-coaxial converter 16 may enable data (e.g., in the form of signals) sent from the one or more sensors 12 via the UTP cable 14 to be provided to the processing circuitry 20 via the coaxial cable 18. As such, the UTP-to-coaxial converter 16 may enable devices (e.g., the one or more sensors 12 and the processing circuitry 20 (or a printed circuit board (PCB) on which the processing circuitry is disposed)) with connections to different types of cables (e.g., coaxial cables and twisted pair cables) to be communicatively coupled to one another.

The coaxial cable 18 may include any suitable coaxial cable. Generally speaking, coaxial cables typically include an inner conductor that is surrounded by a shield, and an insulating material (e.g., a dielectric) that separates the inner conductor and the shield. Coaxial cables may also include sheath or jacket that surrounds the inner conductor, shield, and insulating material. Accordingly, while the UTP cable 14 may be unshielded, the coaxial cable 18 may be shielded. Examples of types of coaxial cables that may be used as the coaxial cable 18 include, but are not limited to, Radio Guide (RG) cables such as RG-6 (e.g., RG-6/U. RG-6UQ), RG-8 (e.g., RG-8/U, RG-8X), RG-11 (e.g., RG-11/U), RG-58 (e.g., RG-58/U), and RG-59 (e.g., RG-59/U, RG-59A/U) cables. The coaxial cable 18 may be any coaxial cable suitable for meeting data 100BASE-T1 and/or 1000BASE-T1 data transfer speeds (e.g., 100 megabits per second or one gigabit per second).

The processing circuitry 20 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processing circuitry 20 may include one or more application processors, one or more baseband processors, one or more general purpose processors, or any combination thereof, and perform functions described herein. For example, the processing circuitry 20 may receive sensor data (e.g., in the form of signals) from the one or more sensors 12 via the UTP cable 14, the UTP-to-coaxial converter 16, and the coaxial cable 18. The processing circuitry 20 may process the received signals, for instance, to determine surroundings of the sensor system 10 or a system or device in which the sensor system 10 is included, control the system of device in which the sensor system 10 is located, or both. In other words, the processing circuitry 20 may be capable of processing data generated by LIDAR sensors.

The processing circuitry 20 may be communicatively coupled to memory or nonvolatile storage perform various algorithms, for instance, to process data generated by the one or more sensors 12. Such programs or instructions executed by the processing circuitry 20 may be stored in any suitable article of manufacture that includes one or more tangible, computer-readable media. The tangible, computer-readable media may include the memory and/or the nonvolatile storage, individually or collectively, to store the instructions or routines. The memory and the nonvolatile storage may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processing circuitry 20 to provide various functionalities, such as processing signals generated by the one or more sensors 12 (e.g., as received from the UTP-to-coaxial converter 16).

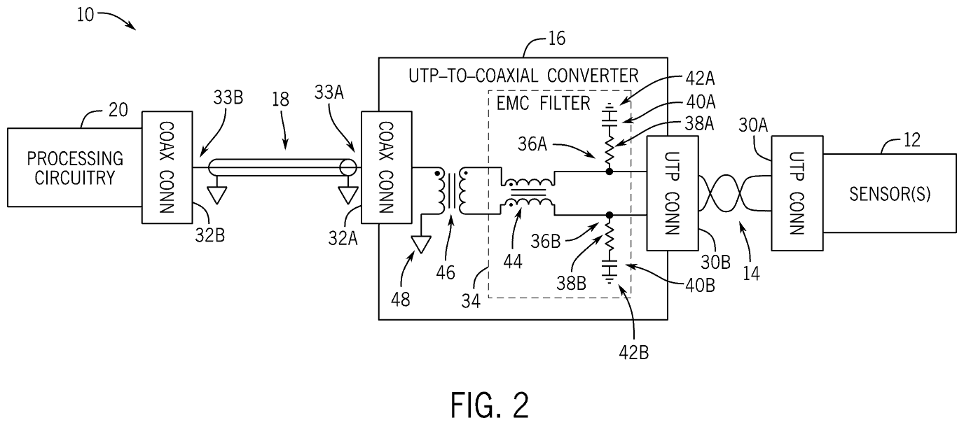

To help provide more detail regarding the sensor system 10, FIG. 2 is another block diagram of the sensor system 10, according to embodiments of the present disclosure. As illustrated, FIG. 2 includes the one or more sensors 12, the UTP cable 14, the UTP-to-coaxial converter 16, the coaxial cable 18, and the processing circuitry 20. As also illustrated, the one or more sensors 12 include a UTP connector 30A, which may connect to one end the UTP cable 14. In other embodiments, the UTP connector 30A may be separate from the one or more sensors 12 and communicatively coupled to the one or more sensors 12. The UTP-to-coaxial converter 16 may also include a UTP connector 30B that may connect to another end of the UTP cable 14. While the one or more sensors 12 and the UTP-to-coaxial converter 16 are each illustrated as having one UTP connector 30 (collectively referring to the UTP connectors 30A, 30B), in other embodiments, the one or more sensors 12 may include multiple UTP connectors 30A, the UTP-to-coaxial converter 16 may include multiple UTP connectors 30B, or the one or more sensors 12 and the UTP-to-coaxial converter 16 may both include multiple UTP connectors 30. The UTP connector 30A, the UTP connector 30B, or both the UTP connector 30A and the UTP connector 30B may be or include 100BASE-T1 (e.g., as defined by Institute of Electrical and Electronics Engineers (IEEE) Standard 802.3bw-2015) and/or 1000BASE-T1 ethernet interfaces. As such, the UTP connector 30A and/or the UTP connector 30B may be paired with a 100BASE-T1 and/or 1000BASE-T1 Ethernet cable (which may be the UTP cable 14).

The UTP-to-coaxial converter 16, as illustrated, has a coaxial connector 32A, which connects to a first end 33A of the coaxial cable 18. The processing circuitry 20 may include or be operatively coupled (e.g., communicatively coupled) to a coaxial connector 32B, which connects to a second, opposite end 33B of the coaxial cable 18. While the one or more sensors 12 and the UTP-to-coaxial converter 16 are each illustrated as having one coaxial connector 32 (collectively referring to the coaxial connectors 32A, 32B), in other embodiments, the UTP-to-coaxial converter 16 may include multiple coaxial connectors 32A, the processing circuitry 20 may include or be coupled to multiple coaxial connectors 32B, or the UTP-to-coaxial converter 16 and the processing circuitry 20 may both include multiple coaxial connectors 32 (or the UTP-to-coaxial converter 16 may include multiple coaxial connectors 32A and the processing circuitry 20 may include or be coupled to multiple coaxial connectors 32B). The coaxial connector 32A, the coaxial connector 32B, or both the coaxial connector 32 and the coaxial connector 32B may be configured to be coupled to any suitable coaxial cable (e.g., coaxial cable 18), such as coaxial cables capable of transferring 100 megabits or one gigabit of data per second. As such, the UTP-to-coaxial converter 16 may be configured to transfer data between the UTP cable 14 and the coaxial cable 18 to enable high throughput data (e.g., 100 megabits of data per second (in compliance with 100BASE-T1) and/or 1 gigabit of data per second (in compliance with 1000BASE-T1)).

The UTP-to-coaxial converter 16 may also include filter circuitry 34. The filter circuitry 34 may include electromagnetic compatibility (EMC) filter and be (directly) coupled to the UTP connector 30B. In other words, the filter circuitry 34 may be coupled to the UTP connector 30B without any intervening or intermediate components between the filter circuitry 34 and the UTP connector 30B. Accordingly, the filter circuitry 34 may receive signals from the one or more sensors 12 and filter out or enable pass through of signals in a frequency range or multiple frequency ranges. In other words, the filter circuitry 34 may block or enable pass through of signals (e.g., from proceeding to balun 46 and the processing circuitry 20) in the frequency range(s). For instance, when utilizing unshielded cables (e.g., the UTP cable 14), interference from an environment that the sensor system 10 is in may be introduced. In the context of the sensor system 10 being included in or on a vehicle, the interference may be introduced to the sensor system 10 electromagnetic radiation in or outside the vehicle, such as radio waves (e.g., associated with a radio of the vehicle) or electromagnetic radiation associated with electronic devices in or of the vehicle (e.g., electromagnetic radiation transmitted or received by a phone). As such, the filter circuitry 34 may filter signals received via the UTP cable 14 to remove interference (e.g., signals that interfere with the signals sent by the one or more sensors 12). In one embodiment, the frequency ranges that the filter circuitry 34 may block may include a first frequency range that includes frequency modulated radio frequencies (e.g., 88.0 megahertz. (MHz) to 108.0 MHZ (inclusive)), a second frequency range that includes amplitude modulated radio frequencies (e.g., 540 kilohertz (kHz) to 1700 kHz. (inclusive)), a third frequency that includes satellite frequencies (e.g., 1 gigahertz. (GHz) to 40 GHZ), or any combination thereof.

The filter circuitry 34 may include signal paths 36A, 36B that are coupled to the UTP connector 30B and include respective resistors 38 (referring collectively to resistors 38A, 38B), capacitors 40 (referring collectively to capacitors 40A, 40B), and ground connections 42 (referring collectively to ground 42A and ground 42B). The resistors 38 and capacitors 40 may filter or enable pass through of particular frequencies, such as one or more of the frequency ranges discussed above. The signal paths 36A. 36B are coupled to a choke 44, which may also filter or enable pass through of signals having particular frequencies (e.g., one or more of the frequency ranges discussed above, which may be differ from the frequency range(s) filtered or passed through by the resistors 38 and capacitors 40). Accordingly, the filter circuitry 34 may receive signals from the one or more sensors 12 and generate filtered signals (e.g., signals having frequencies that have not been filtered out or have passed through by the filter circuitry 34).

Additionally, the UTP-to-coaxial converter 16 may include a balun 46 (e.g., a 1:2 balun) that may be coupled to the filter circuitry 34, ground (e.g., signal ground) 48, and the coaxial connector 32A. The balun 46 may receive filtered signals from the filter circuitry 34 and provide the filtered signals to the coaxial connector 32A. As such, the balun 46 may enable the UTP cable 14 and coaxial cable 18 to communicatively couple together without disturbing the impedance arrangement of either. The filtered signals, once received by the coaxial connector 32A, may be sent via the coaxial cable 18 and received by the processing circuitry 20 via the coaxial connector 32B.

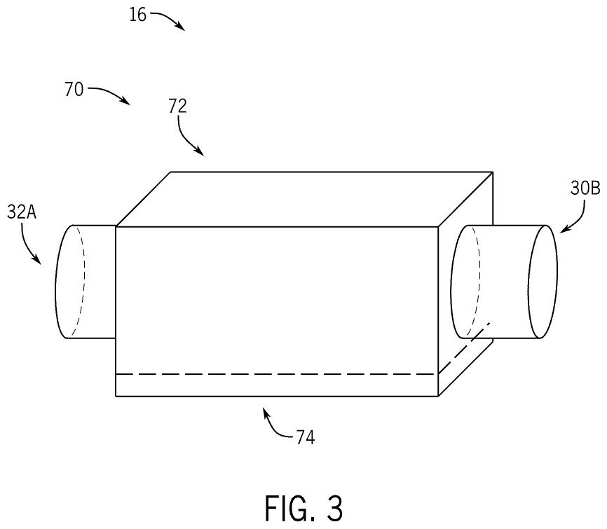

FIG. 3 is a perspective view of the UTP-to-coaxial converter 16, according to embodiments of the present disclosure. The UTP-to-coaxial converter 16 may include a housing 70, which may include an upper portion 72 and a base portion 74 that are separate pieces that interface with one another to form the housing 70. The housing 70 may house components of the UTP-to-coaxial converter 16 fully or partially. For example, the balun 46 and filter circuitry 34 may be located entirely within the housing 70, while the UTP connector 30B and the coaxial connector 32A may be located partially within the housing 70 and partially outside of the housing 70.

The UTP-to-coaxial converter 16 may be unsealed (e.g., capable of receiving fluids or other matter into an interior of the UTP-to-coaxial converter 16 defined by the housing 70 from an exterior environment outside of the housing 70) or sealed (not capable of receiving fluids or other matter from the exterior environment, for example, when the UTP-to-coaxial converter 16 is coupled to the UTP cable 14 and the coaxial cable 18). In sealed embodiments, the UTP-to-coaxial converter 16 may include one or more gaskets that seal the interior of the housing 70 from the exterior environment (e.g., outside of the housing 70). The gaskets may include, but are not limited to, a first gasket that interfaces the UTP connector 30B and the housing 70 (e.g., to prevent fluids from entering the UTP-to-coaxial converter 16 via an interface of the UTP connector 30B and the housing 70), a second gasket that interfaces with the coaxial connector 32A and the housing 70 (e.g., to prevent fluids from entering the UTP-to-coaxial converter 16 via an interface of the coaxial connector 32A and the housing 70), a third gasket that interfaces with the upper portion 72 and base portion 74 of the housing 70 (e.g., to seal a base section of the interior of the housing 70), or any combination of the first gasket, second gasket, and third gasket.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112 (f). However, for any claims containing elements designated in any other manner, it is intended that such elements are not to be interpreted under 35 U.S.C. 112 (f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A system, comprising:
a light detection and ranging (LIDAR) sensor configured to generate one or more signals indicative of sensor data, the LIDAR sensor comprising a first unshielded twisted pair (UTP) connector;
processing circuitry communicatively coupled to a first coaxial connector; and
a UTP-to-coaxial converter comprising:
a second UTP connector communicatively coupled to the first UTP connector of the LIDAR sensor via a UTP cable, wherein the second UTP connector is configured to receive the one or more signals via the UTP cable;
filter circuitry configured to receive the one or more signals from the second UTP connector and generate one or more filtered signals by blocking a portion of the one or more signals having a frequency in a first frequency range; and
a second coaxial connector coupled to the filter circuitry, the second coaxial connector configured to:
receive the one or more filtered signals from the filter circuitry; and
send the one or more filtered signals to the processing circuitry via a coaxial cable that communicatively couples the first coaxial connector and the second coaxial connector.

2. The system of claim 1, wherein the first frequency range comprises a frequency modulated (FM) radio frequency.

3. The system of claim 1, wherein the UTP-to-coaxial converter comprises a housing that houses the filter circuitry and at least partially houses the second UTP connector and the second coaxial connector.

4. The system of claim 3, wherein the UTP-to-coaxial converter comprises a balun configured to receive the one or more filtered signals from the filter circuitry.

5. The system of claim 4, wherein the housing houses the balun.

6. The system of claim 5, comprising one or more gaskets within the housing, wherein the one or more gaskets are configured to seal an interior of the housing from an exterior environment outside of the housing.

7. The system of claim 6, wherein the one or more gaskets comprise:
a first gasket configured to interface with the second UTP connector and the housing; and
a second gasket configured to interface with the second coaxial connector and the housing.

8. The system of claim 7, wherein:
the housing comprises an upper portion and a base portion configured to interface with one another; and
the one or more gaskets comprise a base gasket configured to interface with the upper portion and the base portion of the housing to seal a base section of the interior of the housing.

9. The system of claim 1, wherein the system is included in or on a vehicle.

10. An untwisted pair (UTP)-to-coaxial converter, comprising:
a housing;
a first UTP connector at least partially within the housing and configured to be communicatively coupled to a second UTP connector of a light detection and ranging (LIDAR) sensor via a UTP cable, wherein the first UTP connector is configured to receive one or more signals indicative of sensor data from the LIDAR sensor via the UTP cable;
filter circuitry within the housing and configured to receive the one or more signals and generate one or more filtered signals by blocking a portion of the one or more signals having a frequency in a first frequency range; and
a first coaxial connector at least partially in the housing and configured to:
receive the one or more filtered signals from the filter circuitry; and
send the one or more filtered signals to processing circuitry via a coaxial cable that communicatively couples the first coaxial connector and a second coaxial connector that is communicatively coupled to the processing circuitry.

11. The UTP-to-coaxial converter of claim 10, wherein the housing comprises an upper portion and a base portion configured to interface with one another.

12. The UTP-to-coaxial converter of claim 11, comprising a base gasket within the housing and configured to interface with the upper portion and the base portion of the housing to seal a base section of an interior of the housing from an exterior environment outside of the housing.

13. The UTP-to-coaxial converter of claim 12, comprising:
a first gasket within the housing and configured to interface with the second UTP connector and the housing; and
a second gasket within the housing and configured to interface with the second coaxial connector and the housing.

14. The UTP-to-coaxial converter of claim 10, wherein the first frequency range comprises a frequency modulated (FM) radio frequency.

15. The UTP-to-coaxial converter of claim 14, wherein the filter circuitry is configured to generate the one or more filtered signals by blocking a second portion of the one or more signals having a frequency in a second frequency range different than the first frequency range.

16. The UTP-to-coaxial converter of claim 10, wherein the UTP cable comprises a 100BASE-T1 or 1000BASE-T1 compliant Ethernet cable.

17. The UTP-to-coaxial converter of claim 10, wherein the housing is unsealed from an exterior environment outside of the housing.

18. A system, comprising:
a light detection and ranging (LIDAR) sensor configured to generate one or more signals indicative of sensor data, the LIDAR sensor comprising a first unshielded twisted pair (UTP) connector;
processing circuitry communicatively coupled to a first coaxial connector; and
a UTP-to-coaxial converter comprising:
a housing comprising an upper portion and a base portion configured to interface with one another;
a second UTP connector at least partially within the housing and communicatively coupled to the first UTP connector of the LIDAR sensor via a UTP cable, wherein the second UTP connector is configured to receive the one or more signals via the UTP cable;
filter circuitry within the housing configured to receive the one or more signals from the second UTP connector and generate one or more filtered signals by blocking a portion of the one or more signals having a frequency in a first frequency range;
a balun within the housing and configured to receive the one or more filtered signals from the filter circuitry;
a second coaxial connector at least partially in the housing and communicatively coupled to the balun, the second coaxial connector configured to:
receive the one or more filtered signals from the balun; and
send the one or more filtered signals to the processing circuitry via a coaxial cable that communicatively couples the first coaxial connector and the second coaxial connector; and
a plurality of gaskets within the housing, wherein the plurality of gaskets is configured to seal an interior of the housing from an exterior environment outside of the housing, wherein the plurality of gaskets comprises:
a first gasket configured to interface with the second UTP connector and the housing;
a second gasket configured to interface with the second coaxial connector and the housing; and
a third gasket configured to interface with the upper portion and the base portion of the housing to seal a base section of the interior of the housing.

19. The system of claim 18, wherein the system is included in or on a vehicle.

20. The system of claim 19, wherein the first frequency range comprises a frequency modulated (FM) radio frequency.
